(19) United States
(12) Patent Application Publication
(10) Pub. No.: US 2026/0180449 A1
(43) Pub. Date: Jun. 25, 2026

(54) NON-ISOLATED TO ISOLATED RECONFIGURABLE POWER CONVERTER SYSTEM WITH MULTI-PATH ENERGY AND POWER FLOW

(71) Applicant: The Board of Trustees of The University of Alabama, Tuscaloosa, AL (US)

(72) Inventor: Jaber A. Abu Qahouq, Tuscaloosa, AL (US)

(21) Appl. No.: 19/370,239

(22) Filed: Oct. 27, 2025

Related U.S. Application Data
(60) Provisional application No. 63/738,793, filed on Dec. 25, 2024.

(51) Int. Cl. H02M 3/158

(52) U.S. Cl. CPC H02M 3/1582

(57) ABSTRACT

Reconfigurable power converter topologies that may switch between non-isolated Buck-Boost converter and isolated Dual-Active Bridge (DAB) converter or full-bridge converter. The switching may provide for reconfiguring the power converter inputs and outputs to series or parallel connections in accordance with design needs. The implementations of the disclosure may be utilized for electrified transportation renewable energy storage and power grid support.

### CROSS REFERENCE TO RELATED APPLICATION

This application claims priority to U.S. Provisional Patent Application No. 63/738,793, filed Dec. 25, 2024, entitled “NON-ISOLATED TO ISOLATED RECONFIGURABLE POWER CONVERTER SYSTEM WITH MULTI-PATH ENERGY AND POWER FLOW,” the disclosure of which is expressly incorporated herein by reference in its entirety.

### STATEMENT REGARDING FEDERALLY FUNDED RESEARCH

This invention was made with government support under Grant No. DE-EE0010402 awarded by U.S. Department of Energy (DOE). The government has certain rights in the invention.

### BACKGROUND

There are two types of power converters in terms of utilizing a power transformer or not. Non-isolated power converters which do not utilize power transformers as part of their circuit and the other are isolated power converters which utilize power transformers as part of their circuit. Utilizing a transformer in isolated power converters allow for higher step up and step down conversion ratio either for the voltage or the current which means they allow higher difference between the input and output voltages or the input and output currents. In some applications Isolated power converters help maintain the duty cycle around 50 percent or as close as possible to 50 percent during the variation of input voltages, output voltages, input currents and output currents during the operation of the power converter or the system they operate in which allow for higher power efficiency and therefore less heat and less requirement for thermal management or cooling.

As of today one has to choose one of the two types for the design and when the input and output voltages change one has to read or update or change the power converter in that system because there is a tradeoff between the topologies in terms of how they operate and the ranges of input and output voltages they are suitable for. One example of these applications use batteries and these batteries can have different voltage ranges, even the same battery can vary with large voltage range as the battery charged and discharged. An example of such input source or output is batteries.

### SUMMARY

The present disclosure describes example reconfigurable power converter topologies that may switch between non-isolated Buck-Boost converter and isolated Dual-Active Bridge (DAB) converter or full-bridge converter. The switching may provide for reconfiguring the power converter inputs and outputs to series or parallel connections in accordance with design needs. The implementations of the disclosure are related to a growing industry industries and markets for several applications, such as electrified transportation renewable energy storage and power grid support.

In accordance with an aspect of the disclosure, reconfigurable power converter is disclosed that includes an input circuit that receives an input voltage and includes a plurality of first transistors and first driver circuitry; an output circuit that provides an output voltage and includes a plurality of second transistors and second driver circuitry; a power inductor or a transformer that connects the input circuit to the output circuit; and a switch disposed between the input circuit and the output circuit that is configured to switch the reconfigurable power converter between a non-isolated power converter topology and an isolated power converter topology.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. To illustrate the implementations, there are shown in the drawings example constructions; however, the implementations are not limited to the specific methods and instrumentalities disclosed. In the drawings:

FIG. 1 illustrates an example of a non-isolated power converter;

FIG. 2 illustrates an example of an isolated power converter;

FIG. 3 illustrates an example of a reconfigurable power converter in accordance with aspects of the disclosure;

FIG. 4 illustrates an example power converter topology that includes two reconfigurable power converters in accordance with aspects of the disclosure;

FIG. 5 illustrates an example power converter topology that includes a pre-charge circuit in accordance with aspects of the disclosure;

FIG. 6 illustrates a topology that is similar to FIG. 3 that further includes a power converter in accordance with aspects of the disclosure;

FIG. 7 illustrates an example power converter topology that includes additional optional contactors or switches that may be used to reconfigure the inputs and outputs to be connected in series and/or in parallel when operating in non-isolated Buck-Boost mode in accordance with aspects of the disclosure;

FIG. 8 illustrates an example power converter topology that expands the power converter to more than two isolated DAB sides and non-isolated Buck-Boost channels in accordance with aspects of the disclosure; and

FIG. 9 illustrates the example power converter topology FIG. 7 configured as two isolated power converters.

### DETAILED DESCRIPTION

The present disclosure describes methods and systems that greatly enhance the process and efficiency for utilizing batteries and other storage devices, among other sources and loads.

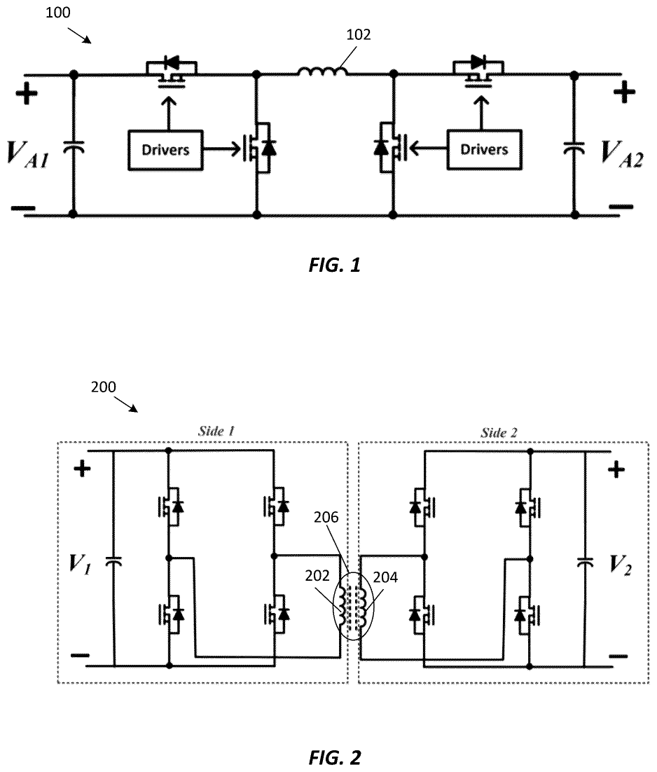

Referring to FIG. 1, there is illustrated an example non-isolated power converter 100. The example of FIG. 1 illustrates a Buck-Boost converter. The non-isolated power converter 100 includes a power inductor 102 between the input (or output) V_{A1} and output (or input) V_{A2} depending on the energy/power flow (which could be bi-directional). Typically, the power inductor is a two terminal device that includes one winding. Non-isolated power converter 100 do not include a transformer, thus do not provide any physical separation between the input V_{A1} and output V_{A2}. Typically, this makes them smaller and lighter.

Referring to FIG. 2, there is shown an example of an isolated power converter 200, which is configured as a Dual Active Bridge (DAB) converter. As shown, two windings 202 and 204 are used to form a transformer 206 to provide the electrical isolation so that power is transferred from the input (or output) V₁ and output (or input) V₂ (depending on the energy/power flow which could be bi-directional) using electromagnetic energy. Typically, a transformer has two or more windings with four or more terminals. The transformer 206 can be used for stepping up and down the voltage or current in addition to providing the electrical isolation. In the isolated power converter 200, the input (or output) V₁ and output (or input) V₂ have separate grounds (even though not required) whereas in a non-isolated converter of FIG. 1, the input and output typically share a common ground.

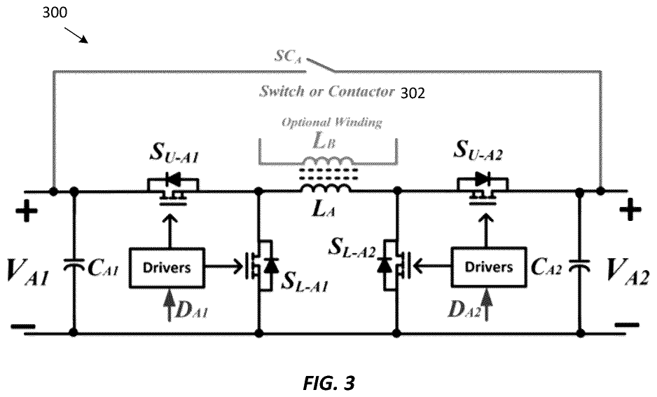

With reference to FIG. 3., there is illustrated a reconfigurable power converter topology 300 in accordance with aspects of the disclosure. The reconfigurable power converter topology 300 realizes a non-isolated Buck-Boost converter when contactor or switch SC_{A} 302 is open, such as the one shown in FIG. 1. When the contactor or switch SC_{A} 302 is closed, the reconfigurable power converter topology 300 can be reconfigured to realize one side of the DAB converter shown in FIG. 2. The contactor or switch SC_{A} 302 may be instructed to open or close in accordance with a command from a controller automatically, manually, or a combination of both. Thus, addition contactor or switch SC_{A} 302 within the reconfigurable power converter topology 300 provides for a novel implementation where a non-isolated power converter having relatively low conversion ratio can be converted from a non-isolated topology into an isolated topology, or one side of two sides of an isolated topology.

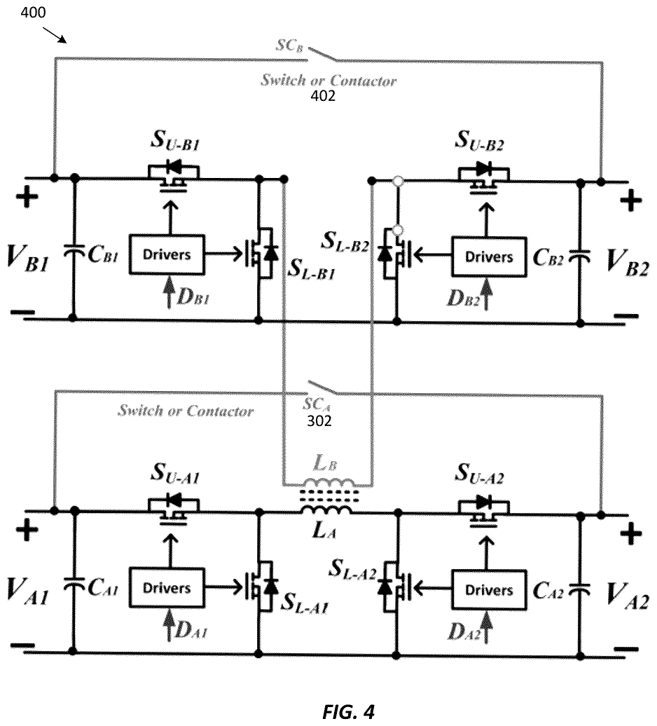

With reference to FIG. 4, there is illustrated another example of a power converter topology 400 that includes two reconfigurable power converters of FIG. 3. In the topology 400, a complete isolated DAB with two sides can be realized by implementing two switches S_{CA} 302 and S_{CB} 402 and commanding or manually closing the switches S_{CA} 302 and S_{CB} 402. In particular, by coupling two power inductors L_{A} and L_{B}, the full DAP isolated power converter topology is obtained having, e.g., a high step up and step down voltage or current conversion ratio. When switches S_{CA} 302 and S_{CB} 402 are open, the topology 400 provides two non-isolated Buck-Boost converter(s). The two non-isolated power converters may operate independently or together (e.g., in parallel or in series).

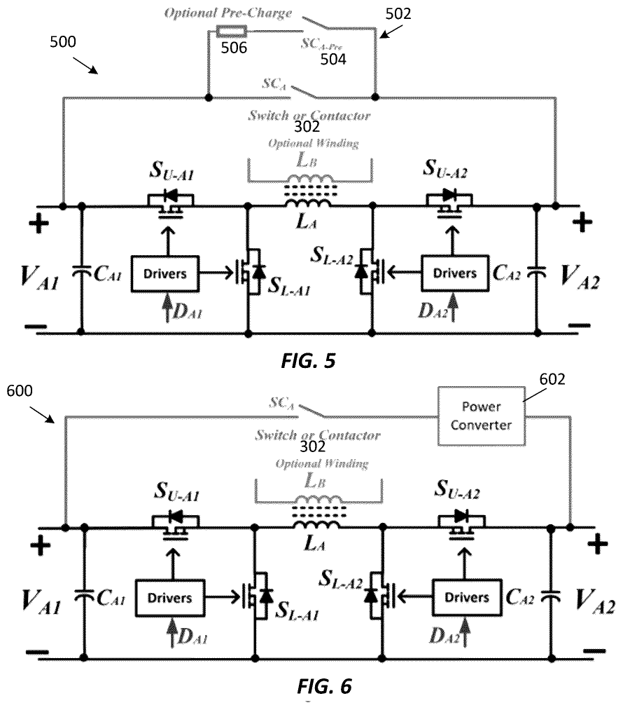

Referring to FIG. 5, there is illustrated another example of a power converter topology 500. The topology 500 is similar to that shown in FIG. 3 but includes a pre-charge circuit 502 that includes a resistor 506 and a switch SC_{A-pre} 504 that may be used to equalize the voltages V_{A1} and V_{A2} by closing SC_{A-pre} 504 before closing SC_{A} 302. Such topology 500 is useful, for example, when either V_{A1} or V_{A2} or both are battery sources. If batteries are connected together with different voltages, the additional path provided by the pre-charge circuit 502 will balance the voltages at the input (V_{A1}) and the output (V_{A2}) such that they are equal before switch SC_{A} 302 used to reconfigure the topology 500 from non-isolated to isolated by closing the switch SC_{A} 302. In operation, the pre-charge circuit 502 is a temporary circuit used for a short time as the topology 500 is switched from non-isolated configuration to isolated configuration, which is novel aspect of the operation of the topology 500 when batteries or other energy storage devices are used.

In another example configuration, FIG. 6 shows a topology 600 that is similar to the converter 300 in FIG. 3 but includes a power converter 602. The power converter 602 may be used when the voltages V_{A1} and V_{A2} are not equal when SC_{A} 302 is closed. This additional converter can be used to be able to operate with different V_{A1} and V_{A2} or to balance V_{A1} and V_{A2}.

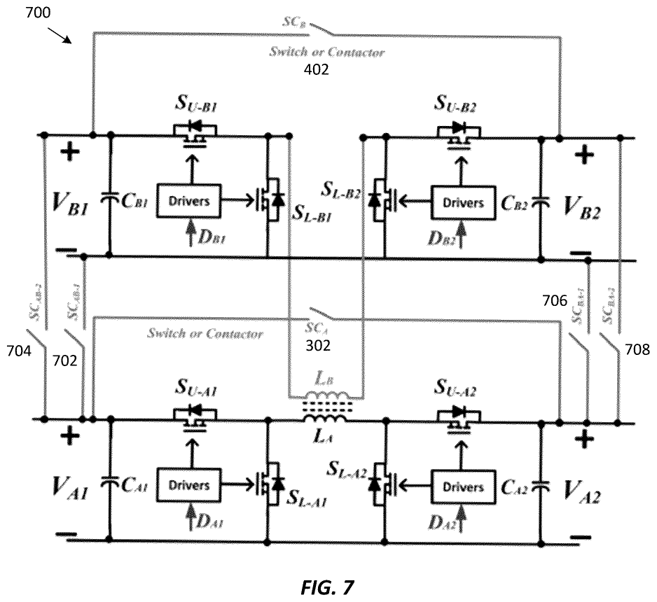

FIG. 7 shows an example power converter topology 700 that includes additional optional contactors or switches such as SC_{AB-1} 702, SC_{AB-2} 704, SC_{BA-1} 706, and SC_{BA-2} 708, can be used to reconfigure the inputs and outputs to be connected in series and/or in parallel when operating in non-isolated Buck-Boost mode. For example, when SC_{AB-2} 704 is closed, side 1 is connected in parallel, and when SC_{BA-1} 706 is closed side 2 is connected in series. In the topology 700, different number of switches may be connected on the left side (input side) and/or right side (output side) depending depends on requirement. For example, when the switch SC_{AB-2} 704 is closed the inputs of the two circuits are connected in parallel while when the other switch SC_{AB-1} 702, is closed the inputs are connected in series. The same may be realized at the output side.

Thus, the topology 700 provides flexibility for many applications where the switches SC_{AB-1} 702, SC_{AB-2} 704, SC_{BA-1} 706, and SC_{BA-2} 708, may be used to connect the inputs or outputs in series or parallel depending on the current capability or the voltage capability. For example, for higher current capabilities the two converters may be connected in parallel to share the current either at the input or at the output, while they may be connected in series for higher input voltages.

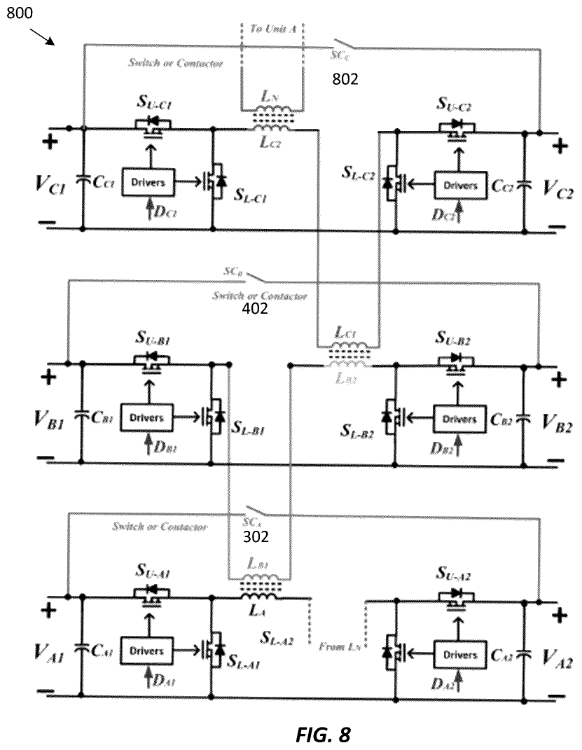

FIG. 8 an example power converter topology 800 that expands the power converter to more than two isolated DAB sides and non-isolated Buck-Boost channels. The topology 800 is provided to show how the number of power converters can be scaled to apply the concepts described above with additional non-isolated topologies or isolated topology having multiple transformers and outputs. In the topology 800, channel A and B could be operating without Channel C to transfer energy/power from A to B then Channel B and C could be operating without Channel A to transfer energy/power from B to A, etc.

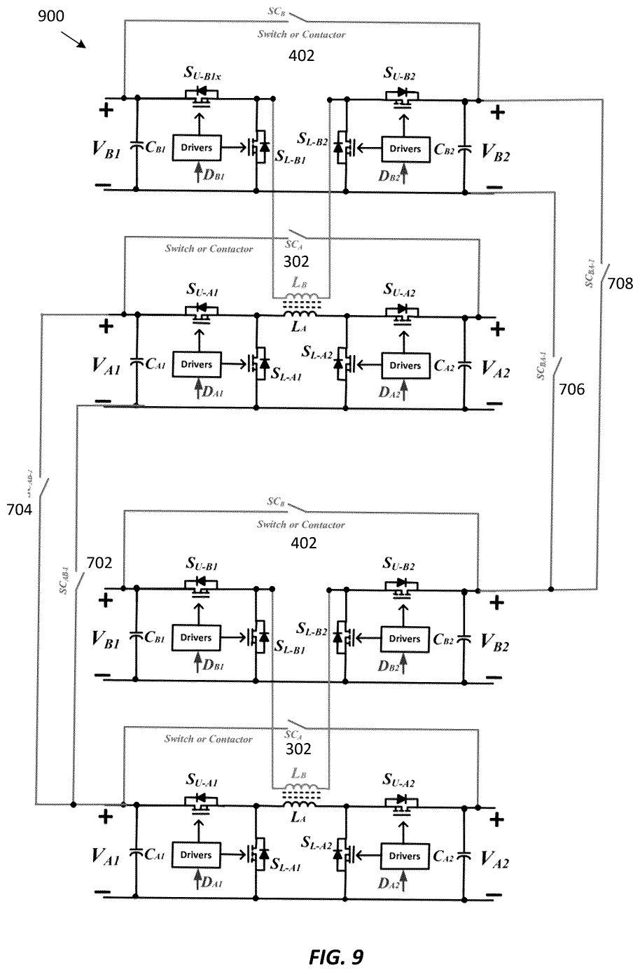

FIG. 9 illustrates the example power converter topology FIG. 7 configured as two isolated power converters.

Thus, implementations of the present disclosure allows for one power converter system that can be used in isolated and non-isolated configurations depending on input and output parameters. Further, the present disclosure provides for online or offline reconfigurability of the system without having to redesign and/or replace the system. For example, if the system has a 100 V battery today, but in the future the battery will have 200V, the power converter can be switched from non-isolated to isolated and vice versa. The implementations of the present disclosure also improves performance and efficiency by using the appropriate configuration based on the input and output parameters (i.e., current or voltage or power). Yet further, the implementations also allow for other reconfigurability and adaptability as described in the claims and figures we discussed earlier.

It should be emphasized that the above-described implementations are merely possible examples of implementations set forth for a clear understanding of the principles of this disclosure. Many variations and modifications may be made to the above-described implementations without departing substantially from the spirit and principles of the disclosure. All such modifications and variations are intended to be included herein within the scope of this disclosure.

What is claimed is:

1. A reconfigurable power converter, comprising:
an input circuit that receives an input voltage and includes a plurality of first transistors and first driver circuitry;
an output circuit that provides an output voltage and includes a plurality of second transistors and second driver circuitry;
a power inductor or a transformer that connects the input circuit to the output circuit; and
a switch disposed between the input circuit and the output circuit that is configured to switch the reconfigurable power converter between a non-isolated power converter topology and an isolated power converter topology.

2. The reconfigurable power converter of claim 1, wherein the reconfigurable power converter is configured as a non-isolated Buck-Boost converter when the switch is open.

3. The reconfigurable power converter of claim 1, wherein the reconfigurable power converter is configured as one side of an isolated Dual Active Bridge (DAB) converter when the switch is closed.

4. The reconfigurable power converter of claim 1, wherein the switch is controlled by a controller that instructs the switch to open and close.

5. The reconfigurable power converter of claim 1, further comprising a second inductor that is coupled with the power inductor such that a transformer or coupled inductors is realized.

6. The reconfigurable power converter of claim 5, further comprising:
a second input circuit;
a second output circuit; and
a second switch,
wherein the second input circuit, second output circuit and second switch realize a fully isolated power converter topology by closing the switch and the second switch.

7. The reconfigurable power converter of claim 6, wherein the full isolated power converter topology has a high step up and step down voltage or current conversion ratio.

8. The reconfigurable power converter of claim 6, wherein the power inductor and second inductor are coupled to provide an isolated Dual Active Bridge (DAB) converter with two sides.

9. The reconfigurable power converter of claim 6, wherein when the switch and the second switch are open, two non-isolated power converters are provided.

10. The reconfigurable power converter of claim 9, wherein the two non-isolated power converters operate independently, in parallel or in series.

11. The reconfigurable power converter of claim 6, further comprising a plurality of additional switches t to reconfigure the input circuits and the output circuits to be connected in series, in parallel or both when operating in a non-isolated power converter topology.

12. The reconfigurable power converter of claim 6, further comprising a plurality of additional switches t to reconfigure the input circuits and the output circuits to be connected in series, in parallel or both when operating in an isolated power converter topology.

13. The reconfigurable power converter of claim 6, further comprising:
a third input circuit;
a third output circuit; and
a third switch,
wherein the third input circuit, third output circuit and third switch realize a selectable non-isolated and isolated power converter topology by selectably closing the switch, the second switch and the third switch.

14. The reconfigurable power converter of claim 1, further comprising a pre-charge circuit that includes a resistor and a switch to equalize the input voltage and the output voltage.

15. The reconfigurable power converter of claim 1, further comprising a power converter in series with the switch to balance the input voltage and the output voltage or regulate the difference between them when they are kept unbalanced.
